(19) United States
(12) Patent Application Publication
(10) Pub. No.: US 2026/0348784 A1
(43) Pub. Date: Nov. 5, 2026

(54) SYSTEM AND METHOD FOR DETERMINING AIRCRAFT CENTER OF GRAVITY USING MEASURED ACCELERATION VALUES AND DYNAMIC WEIGHT DETERMINATIONS

(71) Applicant: C KIRK NANCE, Keller, TX (US)

(72) Inventor: C KIRK NANCE, Keller, TX (US)

(21) Appl. No.: 19/199,021

(22) Filed: May 5, 2025

Related U.S. Application Data
(63) Continuation-in-part of application No. 17/886,677, filed on Aug. 12, 2022, now Pat. No. 12,293,376.
Application No. 17/886,677 is a continuation-in-part of application No. 16/552,383, filed on Aug. 27, 2019, now Pat. No. 11,416,871.
Application No. 16/552,383 is a continuation-in-part of application No. 15/917,149, filed on Mar. 9, 2018, now Pat. No. 11,410,183.
Application No. 15/917,149 is a division of application No. 14/924,332, filed on Oct. 27, 2015, now Pat. No. 10,089,634.

(51) Int. Cl. G01M 1/12; B64C 25/00; B64C 25/60

(52) U.S. Cl. CPC G01M 1/127; B64C 25/001; B64C 25/60

(57) ABSTRACT

A system and method are provided for determining the center of gravity of an aircraft, when the ability to physically measure the weight supported by the aircraft main landing gears is not available. Sensors are used to dynamically measure the weight supported by an oleo type nose landing gear. Additional sensors are used to measure aircraft acceleration, speed, and engine thrust and to provide data to software algorithms for determining a total weight of the aircraft. The amount of weight determined to be the total aircraft weight is reduced by the amount of weight determined to be supported by the nose landing gear to further determine the weight supported by the combined main landing gears. The amount of weight and position of the combined landing gears and the amount of weight and position of the nose landing gear are used to further determine the center of gravity of the aircraft.

This application is a continuation-in-part of U.S. patent application Ser. No. 17/886,677, filing date Aug. 12, 2022, a continuation in part of application Ser. No. 16/552,383, filing date Aug. 27, 2019, a continuation-in-part of U.S. patent application Ser. No. 15/917,149, filing date, Mar. 9, 2018, a division of U.S. patent application Ser. No. 14/924,332, filing date Oct. 27, 2015, the contents of such applications and issued patents resulting therefrom being incorporated herein in their entirety.

### FIELD OF THE INVENTION

The present invention relates generally to determining the longitudinal Center of Gravity (“CG”) of an aircraft, by identifying the distribution of total aircraft weight between the aircraft's Nose Landing Gear (“NLG”) and combined Main Landing Gears (“MLGs”) and specifically to a novel system and set of methods which use a measured weight from the aircraft's NLG and computed weight of the combined MLGs in determining the aircraft CG, when a measured weight of the combined MLGs is not available.

### BACKGROUND OF THE INVENTION

Airlines around the world dispatch their fleets of fully loaded aircraft, for thousands of flights each day. Aviation Regulators such as the Federal Aviation Association (“FAA”), which regulates aviation activities within the United States, and the European Aviation Safety Association (“EASA”), which regulates aviation activities throughout Europe, have determined several safety hazards associated with certain typical airline procedures. The hazard associated procedures relate to how the airlines configure their aircraft performance settings before dispatching the aircraft for take-off and flight. These safety hazards have been identified, for example, within an industry leading safety publication produced by EASA called “European Plan for Aviation Safety” (“EPAS”). (European Union Aviation Safety Agency—EPAS Vol. II 2024 Edition, Best Intervention Strategy for the safety issue “Entry of Aircraft Performance Data”).

In this publication, EASA discusses improving take-off safety, and when and under what conditions a flight crew should be alerted to execute a “rejected take-off” as the aircraft advances down a runway. EASA advises that such alert, a “reject the take-off alert”, should be announced when the aircraft's aerodynamic performance settings, such as flaps and trim, are identified as being improperly set for the current take-off environment. For example, the alert should be announced upon confirmation that prior flight crew inputs, which determine critical aircraft flight-surface settings, have been wrongly configured. The alert should be announced before the aircraft reaches a critical location along the take-off run, to allow adequate remaining runway to perform and execute a safe rejected take-off.

EASA has identified three foundational pillars of aircraft performance criteria, needed to increase take-off safety. Within the Best Intervention Strategies, the three pillars EASA identified are:
1. Onboard Weight and Balance System (OBWBS)
   A system which will measure and sum the actual weights at each landing gear, of the aircraft, as opposed to compiling various weight assumptions to compute the aircraft take-off weight, using average passenger weight assumptions and average checked-bag weight assumptions;
2. Take-Off Performance Monitoring System
   A system which measures the acceleration of the aircraft, as it progressed down a runway, to confirm the aircraft has reached a sufficient speed, in relation its current location along the runway, to successfully take-off before the aircraft reaches the end of the runway;
3. Position Checking System
   A system which monitors the aircraft position along the various taxi-ways of the airport, to assure the aircraft enters the correct runway, at the correct runway intersection, to confirm the aircraft has a sufficient runway length, to take-off before the aircraft reaches the end of the runway.

These pillars are being consolidated into a new safety system, currently referred to as: Take-Off Performance Monitoring System (“TOPMS”); and potentially being re-titled to what will subsequently be called: Take-Off Performance Awareness and Alerting System (“TOPAAS”).

To increase safety, aviation Regulators seek to include these critical aircraft performance monitoring features in the original aircraft configuration build. However, some aircraft manufacturers (Original Equipment Manufacturers (“OEMs”)) are resistant to any new requirements to install additional hardware on new aircraft being built along current aircraft assembly lines. Such OEMs argue that confirmation of a correct aircraft weight can be done with existing equipment and hardware such that any TOPMS data input requirements are already fulfilled by existing hardware on the aircraft. Therefore, the OEM's state that any additional requirements will only add unnecessary complexity to the aircraft assembly process.

Within the EASA—Best Intervention Strategy (“BIS”), there is a requirement for determining the Weight and Center of Gravity (“CG”) of the aircraft. Today's OBWBSs are well suited to do this. In some OBWBSs, pressure sensors attached to the aircraft's oleo type landing gear struts are used to measure internal strut pressure to determine the weight supported by the aircraft's NLG and the weight supported by the combined MLGs. Summing these three (3) respective weights, determines the total weight of the aircraft. The relationship between the amounts of these respective NLG and combined MLGs weights, and the location of these respective weights, correlated as a percentage of the total aircraft weight, will identify the location of the aircraft CG.

Alternatively, in other OBWBSs strain-gauge sensors bonded to load-bearing components of the landing gear struts may be used to measure the changing loads experienced by those respective ground-load bearing components, to provide a total weight of the aircraft, and the three (3) respective landing gear weight values. Each measurement option delivers the solution for providing accurate Weight and CG information.

An alternate and different method, determines the total weight of the aircraft using Newton's 2^{nd} Law of Motion, by measuring the aircraft's total engine thrust in relation to the horizontal acceleration of the aircraft, when:
F=ma.
Stated as follows:
   The acceleration of an object as produced by a net force is directly proportional to the magnitude of the net force, in the same direction as the net force, and inversely proportional to the mass of the object.
Where: F—force (provided by the combined engine thrust of the aircraft)
   m—mass (weight) of the object (being the aircraft)
   a—acceleration of the object (being the aircraft)

The aircraft mass can be determined from take-off acceleration by applying F=ma, where F is the net force (engine thrust, minus drag and friction), m is the aircraft mass, and a is the acceleration. By measuring the acceleration of the aircraft during takeoff and knowing the net force, the mass can be calculated.

Many if not most of today's modern aircraft have onboard accelerometers, as well as capabilities to measure the total thrust (force) from the aircraft engines, as the aircraft begins its take-off run. These same aircraft have the capability, by measuring wheel-speed, to be used to determine the rate of acceleration for the aircraft. Thus, these aircraft have built in capability to generate and provide access to the datasets that can be used to determine the total weight of the aircraft.

When asking aircraft designers how they might determine the aircraft's CG from monitored acceleration, the common comment received is: “measuring the aircraft's CG cannot be done.” This statement is accurate with respect to using measured acceleration values in isolation. Though the total weight of the aircraft can be determined through acceleration, the distribution of that weight within the aircraft can't be determined via measured acceleration methods alone. Newton's 2^{nd} Law provides an ability to determine the total weight of the aircraft but does not provide the ability to determine the distribution of weight within the aircraft. Thus, there is no ability to identify the aircraft's CG by using just acceleration data.

Aircraft designers are confident that a reasonably accurate aircraft total weight can be determined once the aircraft reaches a groundspeed of 75 kts. It is questionable whether a TOPMS that relies upon a delayed aircraft total weight calculation is desirable. A ground speed along the take-off run of 75 kts is precariously close to the “take-off decision speed” of 135 kts (referred to as: V¹) given that only a few seconds elapse between reaching the two speeds. The aircraft's typical rotation speed, the speed at which the pilot rotates the aircraft to raise the NLG and position the aircraft's wings at a proper attach-angle for flight, is 145 kts (referred to as: V^{R}). Thus, the aircraft surpasses the lower 75 kt and V¹ speeds only seconds before the aircraft must take-off, leaving only seconds for a TOPMS to make all of the necessary calculations, to alert the pilot of aircraft setting problems, and for the pilot to properly react to abort the flight and commit to reject the take-off.

There have been efforts made to address issues related to determining an aircraft's center of gravity. For example, U.S. Pat. No. 8,060,296, to Vetsch (“Vetsch”) provides a system and method that uses static weight landing gear load measurements together with static or estimated gross weight determinations to calculate CG. Vetsch discloses using a strain sensor such as that provided in U.S. Pat. No. 4,269,070 (Nelson et al) or a strut pressure sensor to determine an “as loaded” weight on the aircraft nose gear. Vetsch further details using gross weight information received from a load manifest, a load and trim sheet, or a ground based system. Thus, Vetsch teaches using information related to the static weight on landing gear and the static weight or estimated weight of the aircraft as a whole.

However, the information used in Vetsch is subject to variances caused by using static weight values. As disclosed in parent application Ser. No. 17/886,677 (now U.S. Pat. No. 11,416,871) using static weight values can cause calculation errors because of, for example, friction in landing gear. Other issues can result in using static strain gauge readings. Likewise, using gross weight calculations derived from gross static weight measurements or estimated weights can cause calculation issues. Thus, using both these types of static or estimated values can compound accuracy issues in calculating CG.

What is needed is a system and method that can be used to accurately calculate CG and avoids calculation accuracy issues resulting from use of static or estimated weight values.

### SUMMARY OF THE INVENTION

It is an objective of the present invention to provide a system and method for determining an aircraft's Center of Gravity by using measured aircraft acceleration calculations and a measured NLG weight. In certain embodiments, the measured aircraft acceleration calculations are used to determine the aircraft total weight. The determined aircraft total weight and measured NLG weight are then used to determine a weight supported by the combined MLGs. In the system and method of the present invention, the measured NLG weight is subtracted from the determined aircraft total weight to determine the amount of weight supported by the combined MLGs. Once respective weight values have been determined at both the NLG position and combined MLGs position, the aircraft CG is determined.

In certain embodiments, a method of dynamically determining the center of gravity of an accelerating aircraft, while in motion, is provided wherein the aircraft is equipped with an oleo nose landing gear strut, a nose landing gear sensor, an acceleration sensor, and a thrust sensor, and the method comprises the steps of: a. using the nose landing gear sensor, determining a measured weight supported by, and at the location of, the aircraft nose landing gear, the measured weight supported by the nose landing gear at the location of the nose landing gear being a measured NLG supported weight; b. operating the aircraft so as to accelerate a total mass of the aircraft to a horizontal speed at or above a predetermined threshold; c. using the acceleration sensor, determining a horizontal acceleration rate of the aircraft, the determined horizontal acceleration rate of the aircraft being a horizontal acceleration rate value; d. using the thrust sensor, determining an amount of applied horizontal force causing the determined horizontal acceleration rate of the aircraft, the amount of applied horizontal force causing the determined horizontal acceleration rate being an applied horizontal force value; e. using the horizontal acceleration rate value and the applied horizontal force value, determining a total weight of the aircraft; f. using the determined total weight of the aircraft, determining a calculated weight supported by, and at the location of the aircraft combined main landing gears (calculated MLG supported weight), by reducing the determined total weight of the aircraft, by the amount of the measured NLG supported weight; g. using the measured NLG supported weight and the calculated MLG supported weight, determining the center of gravity of the aircraft.

In some embodiments of the method, the nose landing gear sensor is a pressure sensor.

In some embodiments of the method, the nose landing gear sensor is a strain-gauge sensor.

In some embodiments of the method, the acceleration sensor is an accelerometer.

In some embodiments of the method, the method further comprises a step of determining one or more horizontal speed values of the aircraft, using a wheel-speed indicator.

In some embodiments of the method, the horizontal acceleration rate value is determined by using two or more of the determined horizontal speed values.

In some embodiments of the method, the thrust sensor is an engine thrust monitor.

In some embodiments of the method, the applied horizontal force value is a net force value that includes multiple horizontal forces impacting the horizontal acceleration rate value.

In some embodiments of the method, the measured NLG supported weight is determined by compensating for friction within the NLG.

In some embodiments of the method, the measured NLG supported weight is a static weight determination made while the aircraft is stationary.

In some embodiments of the method, the measured NLG supported weight is a dynamic weight determination made while the aircraft is in motion.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1 is a side-view of a typical air transport category aircraft, with a tricycle landing gear in the extended position, resting on the ground, illustrating the location of the aircraft longitudinal CG, with various components of the invention.

FIG. 2 is a rear view of the aircraft NLG strut, illustrating weight being applied to the telescopic landing gear, measuring both strut pressure, as well as illustrating the measurement of deflection of the NLG axle.

FIG. 3 is a is a series of side-views of the aircraft, as it accelerates with increases in speed, along the take-off runway.

FIG. 4 is a side view of the aircraft, illustrating the total aircraft weight, distributed between the NLG position and the combined MLGs position.

FIG. 5 is a diagram illustrating weight distribution to the three (3) respective struts, as the landing gear support the ground-loads of the aircraft; and how the respective positioning of respective landing gear weights, are subsequently used to determine aircraft CG.

FIG. 6 is a schematic diagram of the onboard computer, with sensor inputs, existing aircraft system indicators, and software algorithms used in supports a new “dynamic method” for determining the aircraft CG, as the function of this invention.

### DETAILED DESCRIPTION OF THE PREFERRED EMBODIMENT

Aircraft onboard weight and balance systems, which measure aircraft weight, using landing gear strut pressure (or strain-gauge sensor) designs, have demonstrated the ability to accurately determine the respective weight values as applied to the typical three (3) landing gear configuration designs of modern aircraft, along with additional software capabilities to determine the distribution of the measured weight values, in establishing the aircraft CG.

An aircraft is typically supported by plural landing gear struts. In many if not most cases, aircraft are supported by three (3) landing gear struts. Each landing gear strut is designed much like and incorporates many of the features of a typical telescopic shock absorber. The shock absorber of the landing gear strut comprises internal fluids, of both hydraulic oil and compressed gas. More simply said . . . “the weight of an aircraft rests upon three (3) pockets of compressed gas.” The aircraft weight is transferred to and is identified by the measured pressures contained within the landing gear struts. With a typical hydraulic load cell, the weight is proportional to pressure measured in “psi” (pounds per square inch).

As an alternative to measuring strut pressure, oleo-type landing gear struts have various load-bearing elements such as trunnion-pins which connect the landing gear to the airframe, and the landing gear have wheels and tires attached to axles, which will deflect as additional weight is applied or removed. As weight is applied, strain-gauge sensors bonded to those load bearing components (such as the axle) will measure any such deflection as weight amounts are increased or decreased, with the ability to measure the total aircraft weight and associated CG of the aircraft.

The present invention provides a new method requiring installation of a lesser number of load sensors, for determining the aircraft CG, with use of Newton's 2^{nd} Law of Motion as the foundational element in determining the total weight of the aircraft by monitoring and measuring the aircraft acceleration, combined with only the “measured weight” supported by the NLG; to then identify the total aircraft weight, determined from measured aircraft acceleration, then to reduce the total aircraft weight by the measured weight supported by the NLG to determine the weight supported at the combined MLGs position, to further determine the aircraft CG.

It is not the objective of the present invention to describe, nor perfect the ability to compute the “total” aircraft weight of the accelerating aircraft, through the relationships of engine thrust and that aircraft's acceleration patterns; but merely to accept this commonly known method defined within Newton's 2^{nd} Law of Motion as a functional element utilized within this new invention.

The position of the NLG is a known location on the aircraft's fuselage. The position of the MLGs is also a known location on the aircraft's fuselage. Having a known weight value associated with the location of the NLG, compared to a determined weight value associated with the location of the combined MLGs allows for the aircraft's CG to be determined

In summary, this new technology apparatus and methods used in determining the CG of an aircraft in motion, with continuous monitoring and measuring by various load sensors and aircraft indicators which include, but are not limited to:
NLG strut pressure sensor
NLG axle deflection, strain-gauge sensor
Aircraft accelerometer
Landing gear wheel speed indicator
Engine thrust indicator
GPS speed indicator
Other speed and weight indicators and/or technologies

With functions and computations including:
Measured weight supported by NLG
Measured aircraft horizontal acceleration
Measured force generated, by the aircraft's applied engine(s) thrust
Determined total aircraft weight, via force/acceleration
Determined CG of the aircraft

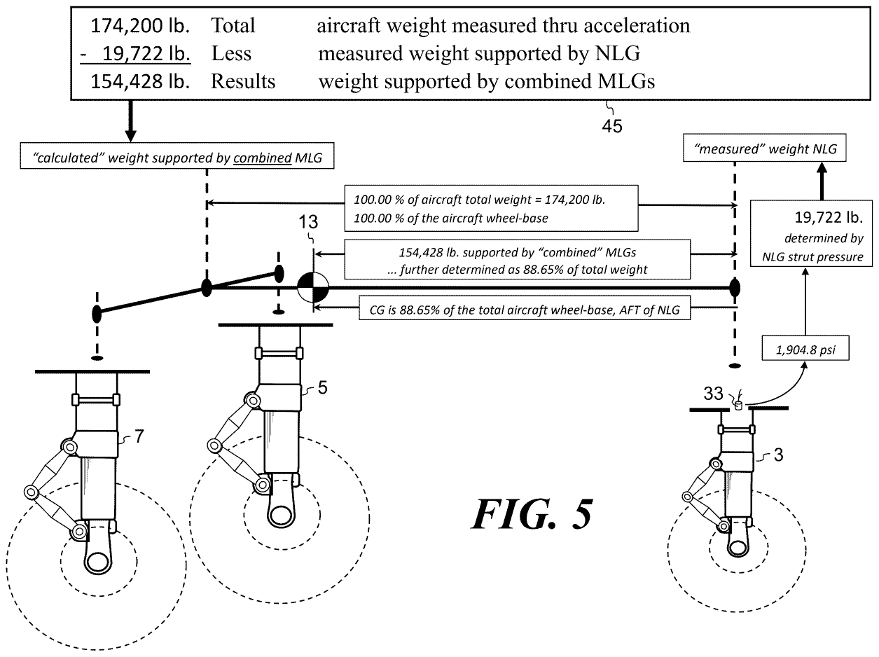

Below is a list of the data recording events by the various landing gear component sensors, and speed and acceleration measuring systems, used as sensory inputs to the system's software within the onboard computer:
Prior to entering the take-off runway; the weight supported by the NLG is determined by measuring strut pressure, (or measuring deflection of NLG load-bearing component(s), being the NLG axle as one of the load-bearing components, but not the only available load-bearing component). In this example of the present invention, strut pressure is used to measure the weight supported at the NLG position.
Subsequent to the aircraft entering the take-off runway, and during the initial stages of the take-off run; in this Example: as the aircraft horizontal acceleration reaches a ground-speed of 75 kts (shown in FIG. 5); the total weight of the aircraft is computed as 174,200 lbs; via Newton's 2^{nd} Law of Motion “F=ma” with the monitoring of the total engine thrust, in relation to the aircraft reaching a specified horizontal acceleration.
As one Example of a method (but not the only method) to identify the aircraft CG; upon identification of the aircraft total weight determined via aircraft engine thrust providing the Force value in the equations, divided by the measured acceleration, the total aircraft weight is determined, followed by subsequent steps:
   1. Reduce from the total aircraft weight value, the amount of weight supported by the NLG, to determine the weight supported by the combined MLG struts;
   2. Determine aircraft CG with typical computations utilizing NLG weight and position, in relation to the combined MLG weights and position, in relation to the total aircraft weight;
   3. Provide the determinations of aircraft Weight and CG, to the aircraft TOPMS; allowing confirmation that aircraft flaps and trim setting are properly configured, when considering current aircraft Weight and CG, and when not; the TOPMS will alert pilots the aircraft take-off should be rejected.

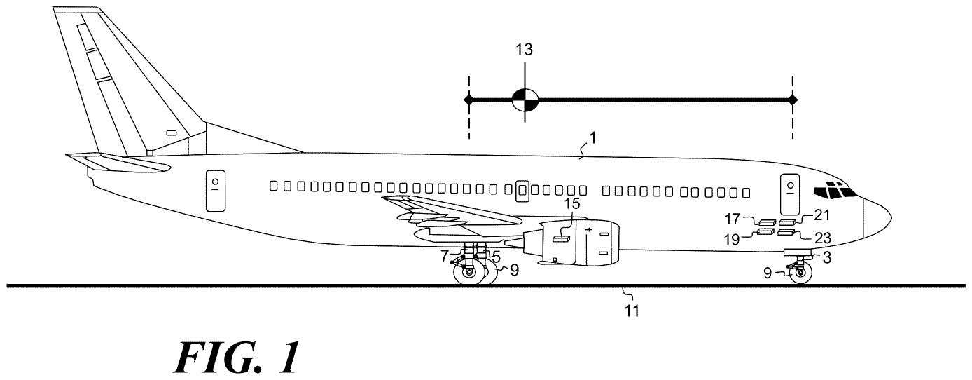

Referring now to the drawings, wherein like reference numerals designate corresponding parts throughout the several views and more particularly to FIG. 1 thereof, there is shown a typical air transport category aircraft 1, with a tricycle landing gear configuration consisting of a NLG 3, and two identical MLGs; being a Left MLG 5 and a Right MLG 7 (both landing gear positioned at the same location longitudinally along the aircraft, but shown in perspective view for this illustration). Landing gears 3, 5 and 7 distribute the total weight of aircraft through tires 9 which are resting on the ground 11. Electronic components which together are used in this invention and are attached to aircraft 1 are: an aircraft landing gear data harvesting computer with Weight and CG processor 17, an aircraft accelerometer 19 which measures aircraft horizontal acceleration, a wheel-speed indicator 21 and a TOPMS (Take-Off Performance Monitoring System) computer 23.

100% of the weight of the aircraft rest upon the combined Left MLG 5 and Right MLG 7, and NLG 3. The aircraft CG 13 can be determined by the comparing the weight supported by the combined MLGs 5 and 7, to the weight supported by the NLG 3. As the percentage of the weight supported by NLG 3 (in this example 11.35%, fully illustrated in FIG. 5) changes in relation to the weight supported by the combined MLGs 5, 7 (in this example 88.65%), so does the location of the aircraft CG 13.

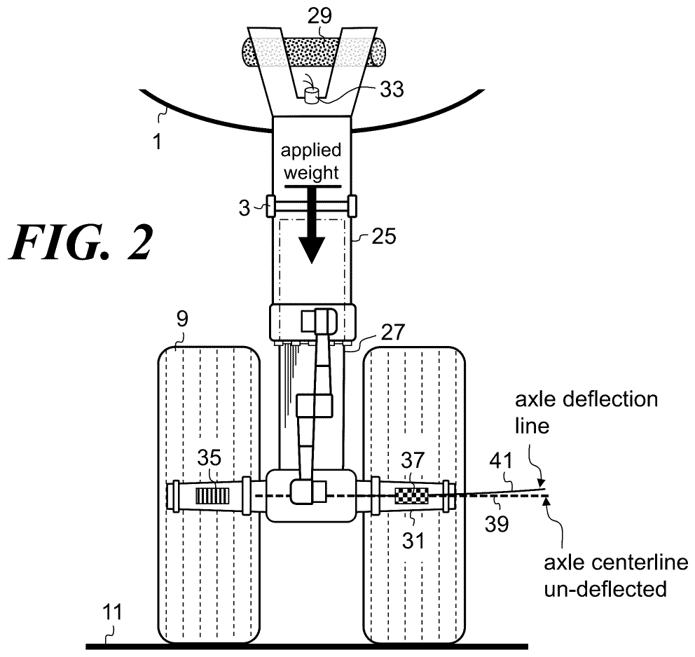

Referring now to FIG. 2, there is shown a rear view of an aircraft NLG 3 strut with tire 9 supporting a portion of aircraft weight, positioned at the location of NLG 3, onto the ground 11. NLG 3 is an oleo type strut having a cylinder 25, in which piston 27 moves telescopically and contain hydraulic fluid and compresses gas. Pressure within NLG 3 is measured and continually monitored by pressure sensor 33. Pressure measurements from sensor 33, multiplied times the horizontal cross-sectional area of strut piston 27 produces the amount of sprung-weight supported by the gas within NLG 3. The non-changing value of un-sprung weight, being items such as: piston 27, axle 31, with wheel and tire assembly 9 are added to the sprung-weight, to provide the total amount of weight supported by NLG 3.

As weight is applied to NLG 3 landing gear axle 31 will deflect and yield proportionally to the additional weight applied. Axle deflection is measured by a bonded strain-gauge sensor 37. A bold dashed-line 39 is shown running horizontal across the centerline of landing gear axle 31 and represents an un-deflected posture of the landing gear axle 31. As weight is applied, axle 31 will deflect. A solid-line 41 representing deflection of axle 31 is shown running adjacent to the un-deflected bold dashed-line 39. The amount of deflection of landing gear axle 31 is proportional to the amount of weight applied to NLG 3 and measured by strain-gauge sensor 37.

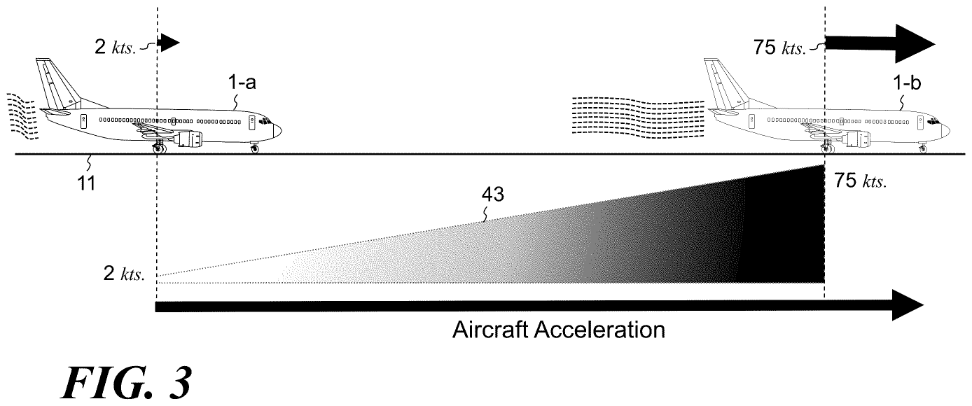

Referring now to FIG. 3 there is shown aircraft 1-a initiating its horizontal acceleration across ground 11, beginning with a ground-speed of 2 kts, and further illustrating an increasing ground-speed shown by the increasing width of the acceleration shaded-wedge 43. As aircraft 1-b reaches a ground-speed of 75 kts, the measured aircraft acceleration is compared to the measured engine thrust; to determine the total weight of aircraft 1-b.

As discussed herein, a number of conventional and commercially available devices and systems can be used to determine the acceleration rate used to calculate the total weight of the aircraft 1-b. Examples of such devices and systems include the aircraft accelerometer 19, the landing gear wheel speed indicator 21, the engine thrust indicator 15, the GPS speed indicator (not shown). In some embodiments, the horizontal acceleration rate value is determined by using two or more determined horizontal speed values. Data concerning drag, wind speed, and friction are used in a conventional manner, along with the measured thrust, to determine the total net force which, in turn, is used as a basis for calculating the total aircraft weight and CG.

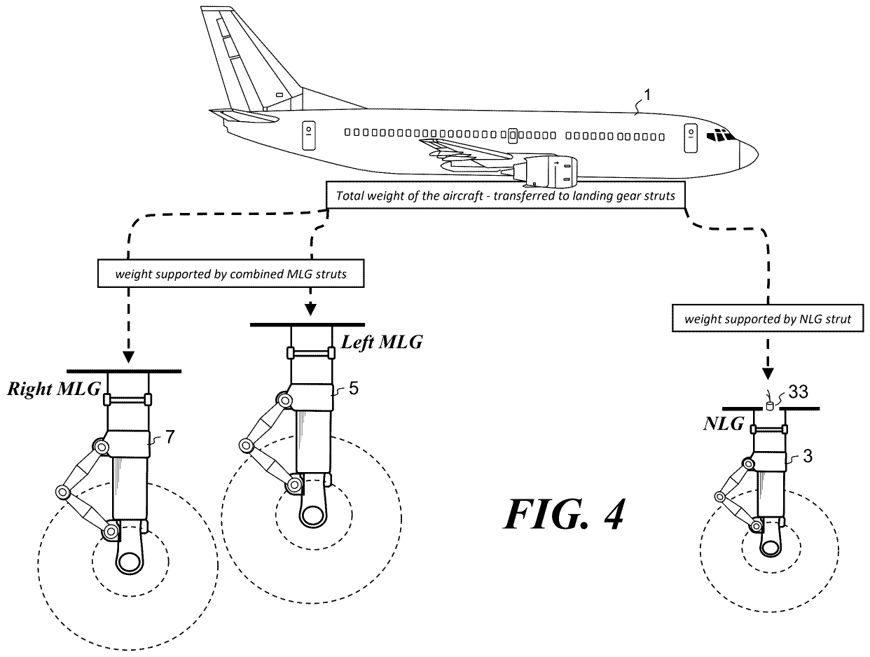

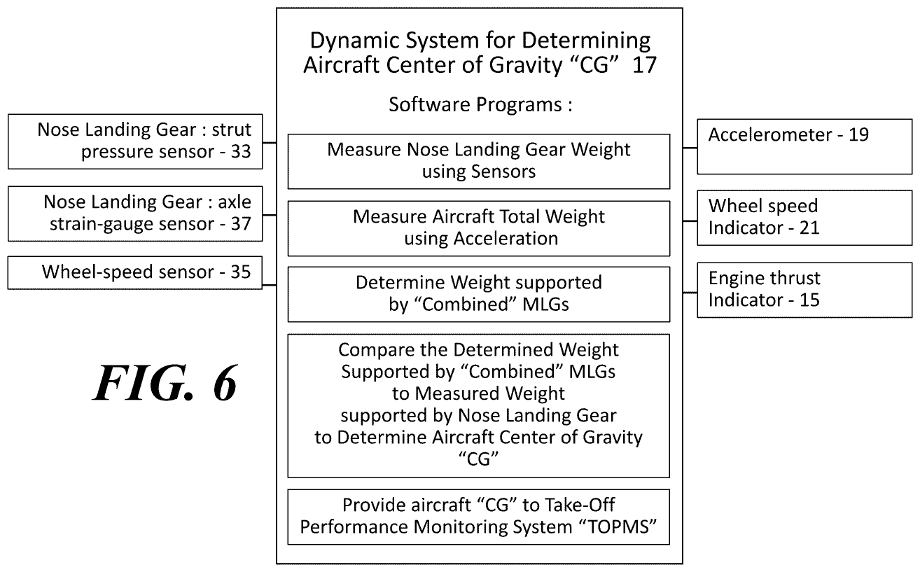

Referring now to FIG. 4 there are shown an illustration of the typical weight distribution of aircraft 1, commonly referred to as the total “ground loads” supported between the NLG 3 and combined Left MLG 5 and Right MLG 7. Determination of the weight supported by NLG 3 is computed through measurements from NLG 3 strut pressure sensor 33. The total weight of aircraft 1 is determined with use of Newton's 2^{nd} Law of Motions (F=ma) where the aircraft's combined engine thrust is applied as the force element, with measurements of aircraft 1 acceleration, which is measured by the aircraft's existing onboard accelerometers 19 (FIG. 6); to compute the total mass of aircraft 1 (described further in FIG. 5).

Referring now to FIG. 5, there is an illustration of a simple method (but not the only method) to determine the location of an aircraft's Center of Gravity—CG 13. With recognition that 100% of the total aircraft weight, is determined via acceleration, with the use of Newton's 2^{nd} Law of Motion (F=ma), and the additional recognition that 100% of the aircraft weight is distributed across the 100% length of the aircraft's wheel-base; being the linear distance between the NLG 3 and the combined MLGs 5 and 7. The aircraft CG can be identified at a location corresponding to a percentage of the linear distance between the NLG 3 and combined MLGs 5 and 7; when the weight determined supported by the combined MLGs 5 and 7 is converted to a percentage of the total aircraft weight.

Respective aircraft landing gear weight values for this Example are shown within upper box 45 of FIG. 5. 174,200 lb. is identified as the total weight of the aircraft, determined through acceleration. 19,722 lb. is identified as the weight supported by the NLG 3, determined through strut pressure measurement. Having no sensors to measure the weight supported by combined MLGs 5 and 7, the weight supported by the combined MLGs 5 and 7 is determined by reducing the 19,722 lb. measured as the NLG 3 weight, from the 174,200 lb. total aircraft weight, to identify the weight supported by the combined MLGs 5 and 7, resulting in: 154,428 lb.

Further recognizing that 154,428 lb. is determined to be 88.65% of the total aircraft weight, it is further recognized that the aircraft CG 13 is located that same 88.65% of the total distance between the NLG 3 and MLGs 5 and 7; behind (aft) of the location of the NLG 3.

Referring now to FIG. 6, there is shown an Apparatus Block Diagram illustrating the various components and aircraft systems which support the apparatus and methods of the invention, where the NLG pressure sensor 33, and/or the NLG axle deflection sensor 37, and wheel-speed sensor 35 are used as inputs to a Dynamic CG Determining System (“DCGDS”) computer 17; along with existing onboard aircraft systems including: the engine thrust indicator 15, the wheel-speed indicator 21, and the aircraft accelerometer 19.

The methods and apparatus of this invention are used for harvesting a variety of data from the aircraft and NLG strut, where multiple sensors for collecting data to continually measure and update the NLG weight used to determine aircraft CG. The methods and apparatus of this invention also comprise the use of conventional data and information necessary to determine other forces besides engine thrust that result in the total net force used as a basis for calculating the total aircraft weight and CG and sensors together with other software and hardware features discussed herein. For example, known data concerning drag, wind speed, friction are used in a conventional manner, along with the measured thrust, to determine the total net force.

DCGDS computer 17 is equipped with an internal clock and calendar to document the time and date of stored data. DCGDS computer 17 has multiple software packages which include:

Functional logic features including:
Measurement of the weight supported by the NLG;
Measurement of the aircraft weight using accelerations; available from existing systems on the aircraft;
Determination of the weight supported by the combined MLGs by reducing the measured weight supported by the NLG, from the determined total weight of the aircraft;
Determining the CG of the aircraft from the determined NLG weight and the dynamically determined, combined MLGs weight;
Providing the determined aircraft CG to the aircraft's Take-Off Performance Monitoring System “TOPMS”;
Using data from external sources and sensors together with other software and hardware features discussed herein, determining forces that make up the total net force used as a basis for calculating the total aircraft weight and CG all being sources of data which input into DCGDS computer 17, then forwarded to TOPMS system 23.

The present invention has been described as adding additional computing with new software as well as new hardware features to prior art apparatus and methods of measuring total aircraft weight and identified the location of the aircraft CG; to allow a new method using both dynamic computations for determining the amounts of respective weights at certain load bearing locations, as well as digital measurements at other locations to identify the aircraft CG; with such embodiments attached to telescopic elements, of oleo type aircraft landing gear struts.

Additionally, as an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of dynamically determining the center of gravity of an accelerating aircraft, while in motion, equipped with an oleo nose landing gear strut, a nose landing gear sensor, an acceleration sensor, and a thrust sensor, the method comprising the steps of:
a. using the nose landing gear sensor, determining a measured weight supported by, and at the location of, the aircraft nose landing gear, the measured weight supported by the nose landing gear at the location of the nose landing gear being a measured NLG supported weight;
b. operating the aircraft so as to accelerate a total mass of the aircraft to a horizontal speed at or above a predetermined threshold;
c. using the acceleration sensor, determining a horizontal acceleration rate of the aircraft, the determined horizontal acceleration rate of the aircraft being a horizontal acceleration rate value;
d. using the thrust sensor, determining an amount of applied horizontal force causing the determined horizontal acceleration rate of the aircraft, the amount of applied horizontal force causing the determined horizontal acceleration rate being an applied horizontal force value;
e. using the horizontal acceleration rate value and the applied horizontal force value, determining a total weight of the aircraft;
f. using the determined total weight of the aircraft, determining a calculated weight supported by, and at the location of the aircraft combined main landing gears (calculated MLG supported weight), by reducing the determined total weight of the aircraft, by the amount of the measured NLG supported weight;
g. using the measured NLG supported weight and the calculated MLG supported weight, determining the center of gravity of the aircraft.

2. The method of claim 1, wherein the nose landing gear sensor is a pressure sensor.

3. The method of claim 1, wherein the nose landing gear sensor is a strain-gauge sensor.

4. The method of claim 1, wherein the acceleration sensor is an accelerometer.

5. The method of claim 1, further comprising a step of determining one or more horizontal speed values of the aircraft, using a wheel-speed indicator.

6. The method of claim 5, wherein the horizontal acceleration rate value is determined by using two or more of the determined horizontal speed values.

7. The method of claim 1, wherein the thrust sensor is an engine thrust monitor.

8. The method of claim 1, wherein the applied horizontal force value is a net force value that includes multiple horizontal forces impacting the horizontal acceleration rate value.

9. The method of claim 1, wherein the measured NLG supported weight has been determined by compensating for friction within the NLG to increase accuracy of the measured NLG supported weight.
